(19) United States
(12) Patent Application Publication
(10) Pub. No.: US 2008/0143599 A1
(43) Pub. Date: Jun. 19, 2008

(54) Processing method for obtaining and displaying a photograph location on digital photos

(76) Inventor: Kuo-Hung Liao, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/640,880

(22) Filed: Dec. 19, 2006

(51) Int. Cl. G01S 5/00

(52) U.S. Cl. 342/357.13

(57) ABSTRACT

A capturing apparatus with a GPS module captures an image to obtain a digital photo and at the same time the GPS module provides longitude and latitude information. According to the longitude and latitude information, the capturing apparatus checks a location database to obtain information regarding the location where the photo was taken. When the capturing apparatus obtains the corresponding location information, it can write it to the digital photo in the storage file format's header field, or display the location information on the capturing apparatus's display module and directly embed the location information into digital photo's image data based on the users' requests.

### BACKGROUND OF THE INVENTION

1. Field of the Invention

The present invention relates to a capturing apparatus, and more particularly to a processing method for obtaining and displaying a location on a digital photo.

2. Description of the Prior Art

In the prior art, when a user wanted to mark the metadata of a location on a digital photo, the user had to input the captured digital photo and corresponding metadata based upon their own recollections, to a computer. Next, the computer would further process the digital photos and the corresponding metadata of the digital photo via application software (for example, Photoshop, PhotoImpact, Illustrator, etc.) for further embedding the metadata into the corresponding digital photo.

Such a method, involving writing the location metadata into the header field of the storage file format of the digital photo, is inconvenient and difficult for users.

### SUMMARY OF THE INVENTION

The present invention provides a first embodiment of a capturing apparatus that includes an image sensing unit, an image processing unit, an image display unit, an internal memory unit, an external memory control unit, a global positioning unit, a processor, an external memory with a location database, and a bottom control unit.

The processor first drives the global positioning unit to automatically download longitude and latitude information regarding the location of the capturing apparatus once the capturing apparatus has been turned on. If a user uses the capturing apparatus to capture an image, the capturing apparatus will produce a corresponding digital photo. The capturing apparatus checks the location database to obtain a corresponding location for the digital photo. Finally, the capturing apparatus can write the location into the corresponding header field of the storage file format of the digital photo and store the digital photo in the external memory.

Moreover, the present invention provides a second embodiment of capturing apparatus that includes an image sensing unit, an image processing unit, an image display unit, an internal memory unit with a location database, an external memory control unit, a global positioning unit, a processor, an external memory, and a bottom control unit.

In this case, the processor first drives the global positioning unit to automatically download longitude and latitude information regarding the location of the capturing apparatus once the capturing apparatus is turned on. If a user uses the capturing apparatus to capture an image, the capturing apparatus will produce a corresponding digital photo. The capturing apparatus further checks the location database to obtain a corresponding location for the digital photo. Finally, the capturing apparatus can write the location into the corresponding header field of the storage file format of the digital photo and store the digital photo in the external memory.

According to above description of the first and second embodiments, the global positioning units can be preset in the capturing apparatus or externally connected to the capturing apparatus. Furthermore, users can set the capturing apparatuses to display corresponding locations on images of digital photos or directly embed corresponding locations into digital photos as described in the first and second embodiments.

### BRIEF DESCRIPTION OF THE DRAWINGS

The above and further advantages of this invention may be better understood by referring to the following description, taken in conjunction with the accompanying drawings, in which:

FIG. 1 is a block diagram that illustrates the capturing apparatus in the first embodiment of the present invention;

FIG. 2 is a block diagram that illustrates the capturing apparatus in the second embodiment of the present invention; and

FIG. 3 is a flowchart of the processing method that illustrates obtaining the location of the captured digital photo for further displaying the location on digital photo.

The drawings will be described further in connection with the following detailed description of the present invention.

### DETAILED DESCRIPTION OF THE PREFERRED EMBODIMENTS

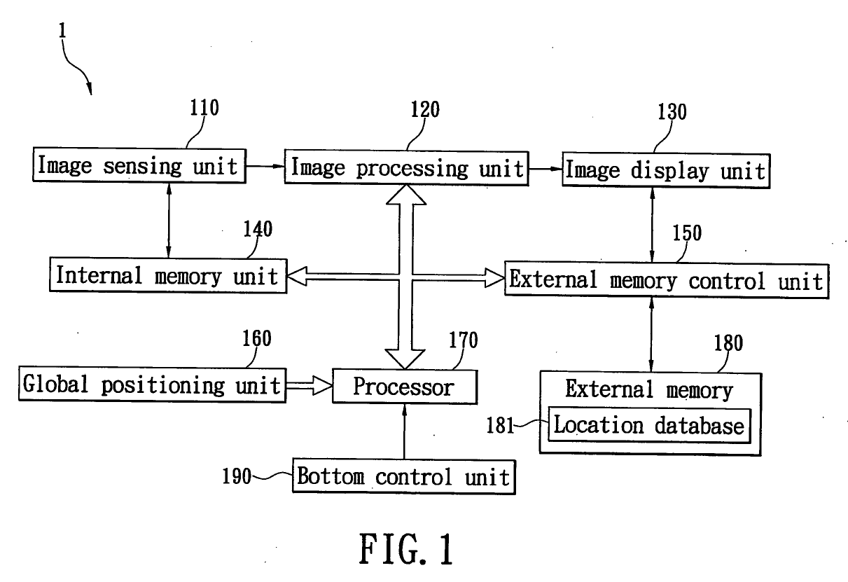

In FIG. 1, a block diagram that illustrates the first embodiment of the capturing apparatus of the present invention is shown. In this case, the capturing apparatus 1 includes an image sensing unit 110, an image processing unit 120, a display unit 130, an internal memory unit 140, an external memory control interface 150, a global positioning system module 160, a processor 170, an external memory 180, and a bottom control interface 190.

After turning on the capturing apparatus 1, the capturing apparatus 1 drives the processor 170 to control internal operations. That is, the processor 170 first drives the external memory control unit 150 to determine whether the external memory 180 is plugged into the capturing apparatus 1. If the external memory 180 is plugged into the capturing apparatus 1, users will be able to capture images to obtain digital photos and then store digital photos in the external memory 180.

Users can enter the control command to drive the processor 170 via the bottom control unit interface 190 to control the image sensing unit 110. The processor 170 processes the images captured by the image sensing unit 110 to obtain the digital photos and store the digital photos in the external memory 180 through the external memory control interface 150. In this case, operation information is stored in the internal memory unit 140 while the processor 170 processes the images.

The global positioning system module 160 automatically downloads longitude and latitude information when the capturing apparatus 1 is turned on. The longitude and latitude information is stored in the internal memory unit 140 so that when an image is captured corresponding information can be written into the corresponding header field of the storage file format of the digital photo.

Moreover, the external memory 180 includes a location database 181 that stores a plurality of location information. Each location information refers to at least one longitude and latitude information. For example, the longitude and latitude information for Taipei, Taiwan is 23°N and 120°E, while the longitude and latitude information for Berlin, Germany is 53°N and 15°E.

The processor 170 obtains the corresponding longitude and latitude information of an image from the internal memory unit 140. Next, the processor 170 obtains the longitude and latitude information from the external memory 180. Next, the processor 170 writes the location information into the corresponding header field of the storage file of the digital photo through the exchangeable image format (EXIF) technique before finally storing the image in the external memory 180.

Users can set the capturing apparatus 1 to display the captured digital photo on the display unit 130 after capturing the image. Furthermore, users can set the capturing apparatus 1 to show the location information of the digital photo and even embed the location information into the image data of the digital photo.

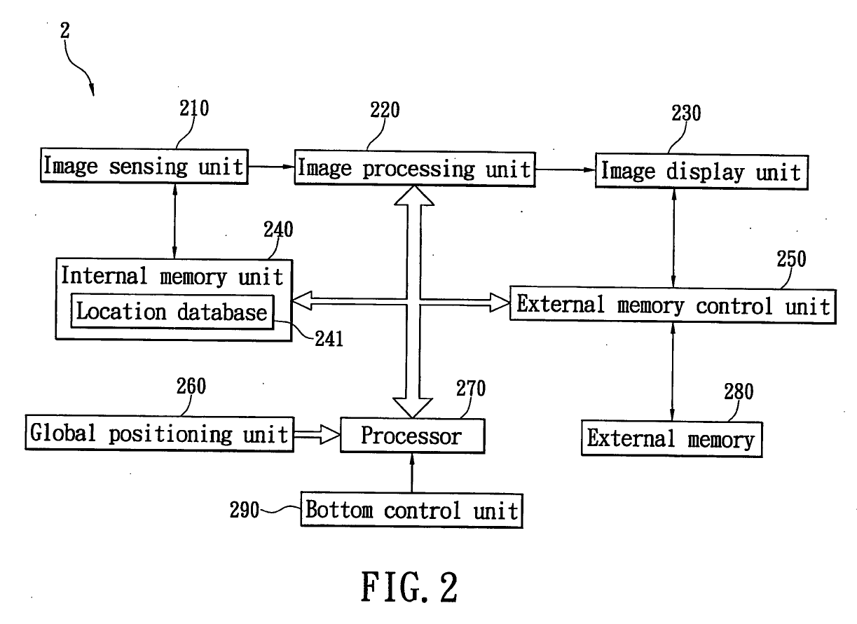

Alternatively, as shown in FIG. 2, the location database 241 in the capturing apparatus 2 of the second embodiment of the present invention can be placed in the internal memory unit 240. Hence, after capturing the image, the processor 270 can obtain the corresponding longitude and latitude information of the digital photo from the internal memory unit 240 and obtain the location information for the longitude and latitude from the location database 241. The processor 270 can further write the location information into the header field in the corresponding storage file format of the digital photo based on the EXIF technique and store the digital photo in the external memory 280.

According to above description of the first and second embodiments, the global positioning system module 160 and 260 can be placed in the capturing apparatus or connect externally to the capturing apparatus.

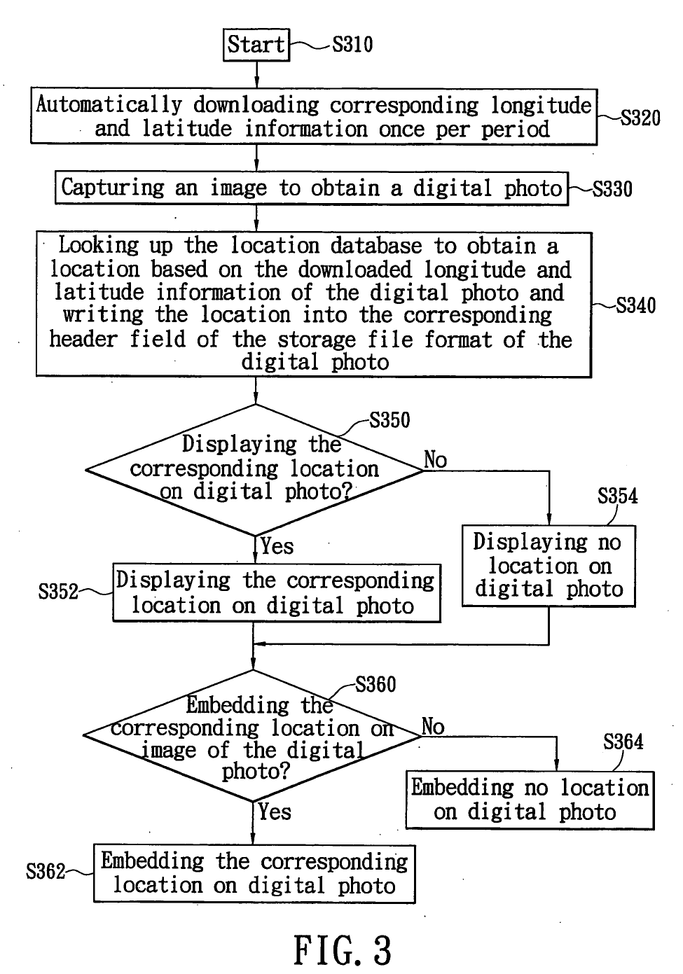

In FIG. 3, a flowchart illustrates how the capturing apparatus obtains and displays the location information on a digital photo. Before capturing an image, the user has to turn on the capturing apparatus (S310). The processor in the capturing apparatus drives the global positioning unit to automatically update the corresponding longitude and latitude information once per period to the internal memory unit based on movements of the user (S320). If the user captures an image the processor will process the image captured by the image sensing unit to obtain a digital photo (S330). In this embodiment, each digital photo the user captures has a corresponding longitude and latitude information.

Furthermore, the processor can obtain location information of the digital photo based on the corresponding longitude and latitude information, from the location database. Next, the processor can write the location information into the header field in the corresponding storage file format of the digital photo based on EXIF technique and store the digital photo in the external memory (S340).

Finally, the user can set the capturing apparatus via the control bottom unit to display the location information written into the header field in the corresponding storage file format of the digital photo displayed on the display unit (S350).

If the user sets the capturing apparatus to display the location information on the digital photo, the processor will drive the display unit to show the location information and the digital photo (S352). If the user doesn't set the capturing apparatus to display the location information on the digital photo, the processor will drive the display unit to show only the digital photo (S354). The user can also choose for the display unit to not display anything, in order to reduce power use for example.

Alternatively, the user can use the bottom control unit to set the capturing apparatus to embed the location information into the image of the digital photo directly (S360). If the user sets the capturing apparatus to embed the location information into the image of the digital photo directly, the processor will process the digital photo and the location information for further embedding the location information into the image of the digital photo (S362). If the user does not set the capturing apparatus to embed the location information into the image of the digital photo, the processor will not process the location information and the digital photo for further embedding the location information directly into the digital photo (S364).

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A processing method for obtaining and displaying location information on a digital photo, comprising:
capturing an image via a capturing apparatus with a GPS module to obtain a digital photo and longitude and latitude information for the location;
finding the location information of the longitude and latitude information in a location database in the capturing apparatus; and
writing the location into the corresponding header field of a storage file format of the digital photo.

2. The processing method for obtaining and displaying location on a digital photo according to claim 1, wherein the location information is stored in the location database beforehand.

3. The processing method for obtaining and displaying location on a digital photo according to claim 1, wherein the location database is placed in the capturing apparatus.

4. The processing method for obtaining and displaying location information on a digital photo according to claim 1, wherein the location database is disposed in an external memory, and the external memory is placed into the capturing apparatus, hence the location database connects to the capturing apparatus.

5. The processing method for obtaining and displaying location on a digital photo according to claim 1, further comprising determining whether to display the location information on the display module of the capturing apparatus based on requests of a user.

6. The processing method for obtaining and displaying location information on a digital photo according to claim 1, further comprising determining whether to embed the location information into the image of the digital photo.
